(19) United States
(12) Patent Application Publication
(10) Pub. No.: US 2014/0040900 A1
(43) Pub. Date: Feb. 6, 2014

(54) STORAGE MANAGING DEVICE AND METHOD AND ELECTRONIC APPARATUS

(71) Applicant: Sony Corporation, Minato-ku (JP)

(72) Inventors: Hu Chen, Shanghai (CN); Hao Zhao, Shanghai (CN); Jing Xu, Shanghai (CN); Junjie Cai, Shanghai (CN)

(73) Assignee: Sony Corporation, Minato-ku (JP)

(21) Appl. No.: 13/953,116

(22) Filed: Jul. 29, 2013

(30) Foreign Application Priority Data
Jul. 31, 2012 (CN) 201210270154.3

(51) Int. Cl. G06F 9/48

(52) U.S. Cl. CPC G06F 9/4806
USPC 718/102

(57) ABSTRACT

A storage managing device and method and an electronic apparatus are provided. The storage managing device is applied to a storage device composed of a plurality of storage blocks, comprising: a thread collecting unit configured to collect threads to be executed in a predetermined time; a thread dividing unit configured to divide the collected threads into n thread groups based on a predetermined strategy; a thread holding unit configured to designate one or more storage blocks to each thread group to store the data necessary for the execution of each thread group into the one or more storage blocks; a thread executing unit configured to execute the threads; and a power consumption setting unit configured to set the one or more storage blocks designated to the threads being executed to an active status, while set other storage blocks to a low power consumption status. With the storage managing device and method and the electronic apparatus according to the embodiments of this invention, the consumption and temperature of the storage device can be lowered significantly while maintaining the capability of the storage device.

### BACKGROUND

The present invention relates to data storage field, and in particular, relates to a storage managing device and method and an electronic apparatus.

With the continuous increase of the scale and speed of computer chips and the development of the applications such as mobile computing and so on, power consumption of computer system is becoming increasingly prominent. On the other hand, the high power consumption causes local temperature of the processor chips to be too high, which directly influences the performance, power consumption, energy consumption, reliability and lifetime of the system. Therefore, the power consumption/temperature-sensitive technology of the computer system has become a hotspot of the current research.

Since the emergence of computer, “memory wall” has always been a bottleneck for improvement of computer performance, the performance of CPU is doubled every 18 months, in contrast, the speed of memory is generally doubled every 10 years, which severely restricts the performance of computer. A multi-core/plural-core generation has come, and as compared with the mono-core architecture, the requirements on the memory have become more demanding, mainly embodied in two aspects of high capacity and high bandwidth.

The current solutions at home and abroad are mainly embodied in the perspectives of (1) technical process, which however brings only about 7% of the benefit each year; (2) structure of the memory, for example, both Intel and AMD have introduced products for multi-core structure, such as the Fully Buffered DIMM (FBDIMM) of Intel and the Socket G3 Memory Extender (G3MX) of AMD, which are characterized in the usage of a bus with a narrower width and a higher frequency to reduce the number of the led connecting each channel, and get more and more memory channels, thereby the parallelism of accessing the memory gets better; (3) algorithm, for example, reducing the delay to increase the data transmission rate, improving the memory scheduling algorithm and so on.

A pursuance of high performance will cause a substantial energy consumption, and in the applications such as server or data center and so on, the power consumption of the DRAM occupies 30% of the entire power consumption, and it increases by 5%-6% per year, therefore, it not only causes a substantial electrical energy waste, but also a severe problem of temperature. The increase of temperature presents a logarithm level relation with the MTTF (mean time to failure), bringing a fatal impact on the reliability of the computer; the increase of the temperature causes longer transmission time delay, resulting in a performance loss; and the static (leakage) power consumption of the device presents an exponential growth relation with the temperature, resulting in a vicious circle of the thermal behavior of the system; and finally, it causes the increase of the cost of the power supply and heat dispersion.

For the problem of the power consumption of the memory, the researches began since the 1990s, during which a series of research results have been achieved, mainly embodied in two aspects: firstly, from the point of view of the hardware, since the integration level of the hardware is increasingly high and the manufacturing process itself improves a great deal, the power consumption of the hardware itself is lowered, and at the same time, the hardware begins to support different power consumption/working status in order to save power consumption to a maximum extent; however, from the aspect of the hardware, the hardware design usually needs to be modified in order to save power consumption, which brings increase in cost of hardware design and development cycle, and it is not very practicable in this sense.

Secondly, from the point of view of reducing power consumption of software, the principle thereof is nothing more than the system uses less hardware resources, or making use of or efficiently managing the different power consumption/working status provided by the hardware; the research area thereof relates to compiler, operating system and application. For example, in “Compiler-Directed Energy Management”, the author organizes the data with a certain accessing property together in advance at the compiling phase, so that other idle modules are in low power consumption status. In the compiler, reducing the power consumption of the memory is a kind of “beforehand” process, which is not suitable for all scenes of application and doesn't have universality. And in the area of application, it is to optimize for a particular application (such as multimedia) so as to achieve the purpose of energy saving, which does not have certain universality.

Therefore, it needs a scheme for further reducing the power consumption of the storage.

### SUMMARY

Therefore, the invention is made in view of the above problem and need in the prior art.

The purpose of the embodiments of the present invention is to provide a storage managing device and method and an electronic apparatus, which is capable of lowering the number of the storage blocks being used by grouping the thread so as to reduce the power consumption of the memory.

According to an aspect of the embodiment of the invention, there provides a storage managing device applied to a storage device composed of a plurality of storage blocks, comprising: a thread collecting unit configured to collect threads to be executed in a predetermined time; a thread dividing unit configured to divide the collected threads into n thread groups based on a predetermined strategy, wherein n is an integer larger than 1; a thread holding unit configured to designate one or more storage blocks to each thread group to store the data necessary for the execution of each thread group into the one or more storage blocks; a thread executing unit configured to execute the threads; and a power consumption setting unit configured to set the one or more storage blocks designated to the threads being executed to an active status, while set other storage blocks to a low power consumption status.

In the storage managing device, the predetermined strategy is, based on a residue obtained by dividing the ID value of a thread by n, distributing the threads with the same residue into one thread group.

In the storage managing device, the thread dividing unit is configured to determine a storage block designated to the thread based on at least one of the category of the thread, the occupancy amount of the storage capacity of the thread and the remaining capacity of the storage block; and distribute the threads designated with the same storage block into one thread group.

The storage managing device further comprises: if the threads in a same thread group are not all executed, the threads in the thread group are executed; and, if the threads in a same thread group are all executed, the threads in a next thread group are executed.

The storage managing device further comprises: a storage block grouping unit configured to group a plurality of storage blocks into n storage block groups; wherein, the thread holding unit is configured to designate one storage block group to each thread group.

According to another aspect of the embodiment of the invention, there provides a storage managing method applied to a storage device composed of a plurality of storage blocks, comprising: collecting the threads to be executed in a predetermined time; dividing the collected threads into n thread groups based on a predetermined strategy, wherein n is an integer larger than 1; designating one or more storage blocks to each thread group to store the data necessary for the execution of each thread group into the one or more storage blocks; executing the threads; and, setting the one or more storage blocks designated to the threads being executed to an active status, while setting other storage blocks to a low consumption status.

In the storage managing method, the step of dividing the collected threads into n thread groups based on a predetermined strategy is specified as: based on a residue obtained by dividing the ID value of a thread by n, distributing the threads with the same residue into one thread group.

In the storage managing method, the step of dividing the collected threads into n thread groups based on a predetermined strategy is specified as: determining a storage block designated to the thread based on at least one of the category of the thread, the occupancy amount of the storage capacity of the thread and the remaining capacity of the storage block; and distributing the threads designated with the same storage block into one thread group.

The storage managing method further comprises: if the threads in a same thread group are not all executed, the threads in the thread group are executed; and, if the threads in a same thread group are all executed, the threads in a next thread group are executed.

The storage managing method, after the step of dividing the collected threads into n thread groups based on a predetermined strategy, further comprises: dividing the plurality of storage blocks into n storage block groups; and the step of designating one or more storage blocks to each thread group is specified as: designating one storage block group to each thread group.

According to yet another aspect of the embodiment of the invention, there provides an electronic apparatus, comprising: a storage device composed of a plurality of storage blocks and a controller comprising: a thread collecting unit configured to collect threads to be executed in a predetermined time; a thread dividing unit configured to divide the collected threads into n thread groups based on a predetermined strategy, wherein n is an integer larger than 1; a thread holding unit configured to designate one or more storage blocks to each thread group to store the data necessary for the execution of each thread group into the one or more storage blocks; a thread executing unit configured to execute the threads, and a power consumption setting unit configured to set the one or more storage blocks designated to the threads being executed to an active status, while set other storage blocks to a low power consumption status.

With the storage managing device and method and the electronic apparatus according to the embodiments of this application, the consumption and the temperature of the storage device can be lowered significantly while maintaining the performance of the storage device.

### BRIEF DESCRIPTION OF THE DRAWINGS

For explaining the technical solution in the embodiments of the invention or in the related art more clearly, the figures necessary in the description of the embodiments or the related art are explained simply as follows, it is obvious for those skilled in the art that the figures in the following description are only some embodiments of the invention, and other figures can be obtained from these figures without inventive labour.

FIG. 1 is a view of the transfer of the power consumption/working status of the DRAM;

FIG. 2 is a schematic block view of the storage managing device according to the embodiment of the present invention;

FIG. 3 is a schematic view of the storage status of the thread in the storage managing device according to the embodiment of the present invention;

FIG. 4 is a schematic view of the active status of the respective storage blocks in the storage managing device according to the embodiment of the present invention;

FIG. 5 is a schematic view showing a buddy algorithm in the related art;

FIG. 6 is a schematic view showing the buddy algorithm in the storage managing device according to the embodiment of the present invention; and

FIG. 7 is a schematic flowchart of the storage managing method according to the embodiment of the present invention.

### DETAILED DESCRIPTION

Hereinafter, the storage managing device and method and the electronic apparatus according to the embodiments of the present invention will be described in detail in combination with the accompanying drawings.

In the current electronic apparatus, the operating system as an intermediate layer of software and hardware, is able to not only perceive the micro-architecture of the bottom layer, but also tightly combine the system behavior of the upper layer; at the same time, the operating system as a resource manager and scheduler has a global view of the system, therefore, the management of the power consumption of the storage device conducted in the operating system level is practicable. The research of the power consumption of the storage device based on the operating system level can be divided into the following three parts.

Firstly, as shown in FIG. 1, there provides some kinds of different power consumption/working status for DRAM (Dynamic Random Access Memory), and the power consumptions in each status are different, however, the storage device can complete a read/write operation only when it is in an active status, the operating system makes use of and efficiently manages the power consumption/working status provided by the hardware, so as to achieve the purpose of energy-saving. Here, FIG. 1 is a view of the transfer of the power consumption/working status of the DRAM.

Secondly, in the operating system, the scheduler acts as the scheduling staff of the thread and determines the behavior mode of the system. In the “Scheduler Based DRAM Energy Management”, the author builds a thread usage table of the bank (BUT: bank usage table), the scheduler will schedule with priority the thread group that has the same storage bank number as the thread running currently to be executed, and the purpose thereof is to make other storage bank idle for a longer time, so as to be in low power consumption status.

In the operating system level, no matter which one of status management, reasonable scheduling, or data reorganization has mitigated the problem of the power consumption of the storage device to a certain extent, however, while solving the problem of the power consumption, it may neglect or introduce new problems such as performance factor, the fragment problem upon data reorganization. Therefore, it still needs certain improvement.

According to an aspect of the embodiment of the invention, there provides a storage managing device applied to a storage device composed of a plurality of storage blocks, comprising: a thread collecting unit configured to collect threads to be executed in a predetermined time; a thread dividing unit configured to divide the collected threads into n thread groups based on a predetermined strategy, wherein n is an integer larger than 1; a thread holding unit configured to designate one or more storage blocks to each thread group to store the data necessary for the execution of each thread group into the one or more storage blocks; a thread executing unit configured to execute the threads; and a power consumption setting unit configured to set the one or more storage blocks designated to the threads being executed to an active status, while set other storage blocks to a low power consumption status.

In the storage managing device according to the embodiment of the present invention, by dividing the threads into different thread groups and designating the storage blocks used so as to set only the storage blocks being used to the active status, the power consumption of the storage device can be reduced efficiently, and at the same time, since not all of the storage blocks are in the active status, the temperature of the storage device can be lowered correspondingly.

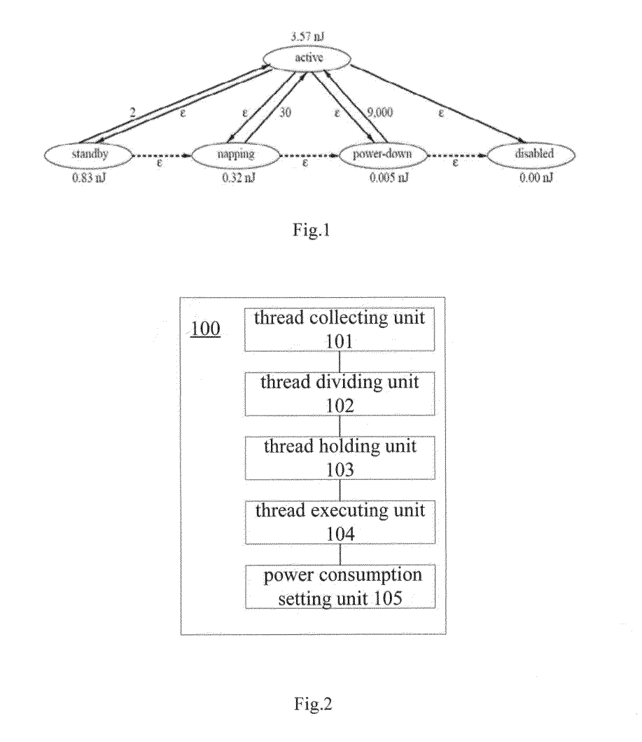

FIG. 2 is a schematic block view of the storage managing device according to the embodiment of the present invention. As shown in FIG. 2, a storage managing device 100 according to the embodiment of the present invention is applied to a storage device composed of a plurality of storage blocks, the storage managing device 100 comprising: a thread collecting unit 101 configured to collect threads to be executed in a predetermined time; a thread dividing unit 102 configured to divide the threads collected by the thread collecting unit 101 into n thread groups based on a predetermined strategy, wherein n is an integer larger than 1; a thread holding unit 103 configured to designate one or more storage blocks to each thread group divided by the thread dividing unit 102 to store the data necessary for the execution of each thread group into the one or more storage blocks; a thread executing unit 104 configured to execute the threads; and a power consumption setting unit 105 configured to set the one or more storage blocks designated to the threads being executed to an active status, while set other storage blocks to a low power consumption status.

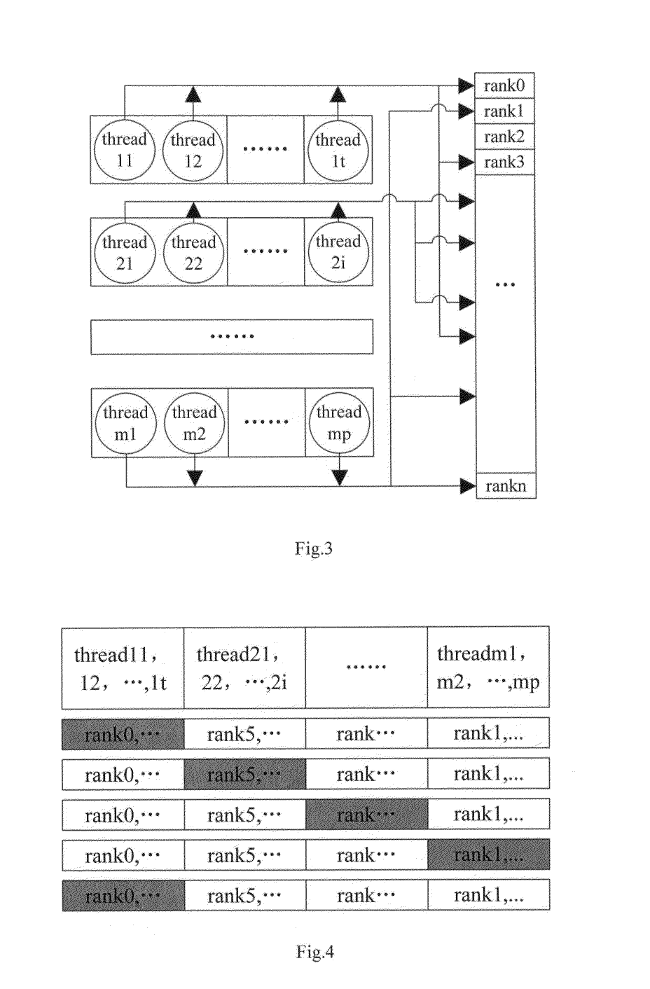

In the architecture of the memory in the current computer system, the memory is divided into a plurality of memory blocks of different levels to be managed, wherein, the memory blocks of each level can carry out power consumption management individually, so that the memory blocks of each level can be set to different power consumption status. In the storage managing device according to the embodiment of the present invention, the threads to be executed are further distributed such that the threads to be executed within a predetermined time are distributed into a plurality of groups to be scheduled. That is, in the storage managing device according to the embodiment of the present invention, the threads are distributed according to the concept of thread group, which can distribute all of the threads in the system into different thread groups. FIG. 3 is a schematic view of the storage status of the thread in the storage managing device according to the embodiment of the present invention. As shown in FIG. 3, t threads of thread 11, 12, . . . 1t are distributed into the thread group 1, also i threads of thread 21, 22, . . . , 2i are distributed into the thread group 2, in the same way, p threads of thread m1, m2, . . . , mp are distributed into the thread group m. And, in the storage managing device according to the embodiment of the present invention, the memory required by all threads in a same thread group is restricted to one or more fixed memory blocks, that is, the data required for the execution of the thread is stored in the one or more fixed memory blocks. As shown in FIG. 3, the memory required by all threads in the thread group 1 is restricted to several memory blocks of level 0, level 3 and so on, in the same way, the memory required by all threads in the thread group m is restricted to several memory blocks of level 1, level n and so on.

Here, the data required for the execution of each thread, for example, the data required to be read for the execution of the thread and the data generated in the thread execution process may be stored basically in one memory block. However, since the execution of the thread may need some other auxiliary data of the operating system, and these data may be included in another one or more memory blocks, in the storage managing device according to the embodiment of the present invention, one or more memory blocks are designated to each thread group so as to store the data required for the execution of the thread group.

Thus, when the scheduling of the operating system is carried out, if a thread in the thread group 1 is selected to be executed, since the data required for the execution of threads in the thread group 1 is all stored in several memory blocks of level 0, level 3 and so on, and other memory blocks don't have data, only these several memory blocks need to be set to the active status, and other memory blocks are set to the low power consumption status, so as to facilitate the reduction of the whole power consumption of the memory. FIG. 4 is a schematic view of the active status of the respective storage blocks in the storage managing device according to the embodiment of the present invention. As shown in FIG. 4, when a thread in the thread group 1 is executed, only the several memory blocks of level 0, level 3 and so on need to be set to the active status. In the same way, when a thread in the thread group 2 is executed, only the several memory blocks of level 5 and so on need to be set to the active status, and all of the other memory blocks are set to the low power consumption status.

In order to avoid the power consumption caused by switching the memory blocks of different levels frequently, the frequency of switching the memory block from the active status to the low power consumption status or from the low power consumption status to the active status can be lowered. In combination with the scheduling strategy of the operating system, to ensure the limitation of the priority and fairness, the threads in a same thread group may be selected to be the threads to be executed next with priority, and immediately after the threads in the thread group are all executed, the next thread group is selected to be executed. Therefore, since the memory blocks required for the execution of the thread in a same thread group are same, when the threads in a same thread group are selected as the threads to be executed next, it is not necessary to switch the status of all memory blocks.

In the storage managing device according to the embodiment of the present invention, the grouping of the threads may be carried out by dividing the ID value of each thread by the number of the group n, that is, the threads with the same numeric value obtained by dividing the ID value of the thread by the number of the group n are distributed into the same group, and the threads with different numeric values are distributed into different groups.

Further, other factors may be considered to determine the predetermined strategy for distributing the threads, and a further description are given as follows.

Firstly, it is needed to determine the memory unit which is capable of switching independently in the memory, that is, the number of the memory blocks, and generally, this number can be known at the time of the system start-up, and is set to N. In consideration of different kinds of the threads, for the system thread, since the data required for the execution thereof are basically system data, all system threads can be forced to use same physical memory blocks, so as to restrict the memory blocks to be used to be specific memory blocks. Further, for the user mode thread, when each user mode thread starts up, which one or more physical memory blocks are used by the thread is determined by the system, for example, when the user mode thread starts up, the user mode thread may demonstrate the usage amount of the memory thereof, i.e., more memory or less memory being needed, then, the operating system may designate one or more memory blocks to the threads to be used according to the status of being occupied of each physical memory block, so as to ensure a well-distributed usage of each memory block.

Further, a dynamic designation may be carried out according to the occupied amount of the memory block during the execution of the thread, that is, in the thread execution process, the memory usage amount of the thread that one or more memory blocks are designated to is considered, and if the status that the above-described memory blocks are occupied by the existing thread is severe, the thread is moved to and designated to the next memory block in order.

Thus, with the designation of the memory blocks mentioned above, the memory blocks that may be used by the threads are saved in a certain table, e.g., table of task_struct, for example, the level of the memory block corresponding to the thread 100 is 3, that is, the thread 100 uses memory block of level 3. With reference to the table of the memory blocks designated to the threads, the threads using same memory block can be distributed into the same thread group, so as to schedule the threads using the same memory block with priority at the time of thread scheduling.

Hereafter, the method of storing the data in the memory blocks is explained.

In the Linux operating system, there exists a storage method called buddy algorithm, which divides all free pages to 10 block groups, wherein, the size of the blocks in each group are pages of exponent of 2, e.g., the size of the blocks in 0^{th} group is 2⁰(1) pages, and the size of the blocks in 1^{st} group is 2¹(2) pages, . . . , the size of the blocks in the 9^{th} group are 2⁹(512) pages. That is, the size of the blocks in each group are same, and the blocks with the same size form one linked list, as shown in FIG. 4. Here, two blocks satisfying the following condition are called buddy: the sizes of the two blocks are same and the physical addresses of the two blocks are continuous. FIG. 5 is a schematic view showing a buddy algorithm in the related art.

The principle of operation of the algorithm is explained by a simple example as follows. It is assumed that the size of the block to be designated is 128 pages. The algorithm searches in the linked list with block size of 128 pages firstly to determine whether there exists such a free block. If so, it directly designates; and if not, the algorithm would search a next block with larger size, in particular, it searches a free block in the linked list with block size of 256 pages. If such free block exists, the 256 pages are divided into two equal parts, one part is designated, and the other part is inserted into the linked list with block size of 128 pages. If free page is not found in the linked list with block size of 256 pages, it continues to search blocks with larger size, i.e., blocks with size of 512 pages. If such block exists, 128 pages are separated from the block with size of 512 pages to satisfy the request, and 256 pages are taken out from the 384 pages to be inserted into the linked list with block size of 256 pages. And then, the remaining 128 pages are inserted into the linked list with the block size of 128 pages. If there are not free block in the linked list of 512 pages yet, the algorithm gives up the designation, and generates an error signal.

And, the reverse of the procedure mentioned above is a release procedure of the block. The buddy algorithm merges the two blocks satisfying the condition described above into one, this algorithm is an iterative algorithm, if the merged block can be further merged with an adjacent block, the algorithm will continue to merge.

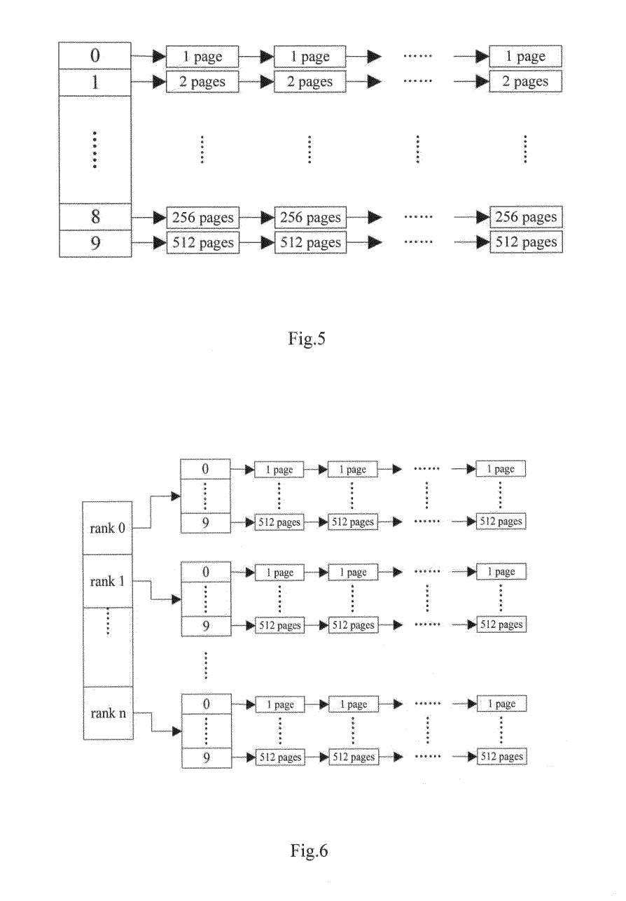

In the Linux system, the buddy algorithm mentioned above is transparent to the information of the bottom layer memory, and this limits the sufficient excavation of the information of the hardware to a certain degree to achieve the effect of energy-saving, and in the storage managing device according to the embodiment of the present invention, the original algorithm is improved to introduce a “buddy algorithm of level perceptive”. That is, layer level information is further added based on the original buddy algorithm, as shown in FIG. 5. The respective buddy algorithms are organized according to different levels, so that the memory blocks in the memory block groups of levels capable of being designated to the threads are searched when the respective memory blocks are designated to the threads, instead of designating arbitrarily as the original buddy algorithm. FIG. 6 is a schematic view of the buddy algorithm in the storage managing device according to the embodiment of the present invention.

In the storage managing device according to the embodiment of the present invention, the buddy algorithm of level perceptive divides all threads in the system according to a predetermined strategy, for example, the threads with the same numeric value obtained by dividing the ID value of each thread by the number of the groups n are distributed into the same group, and the threads with different numeric values are distributed into different groups. Thus, there are n thread groups in the system, and the memory required for the execution of the threads in a same group is designated to one or more memory blocks. The threads of the same group are selected to be executed in order with priority in the scheduling procedure, when the threads of this group are executed, only the memory blocks required for this group need to be set to the active status, and all of other memory blocks are set to the low power consumption status. A next group of threads are selected after all of the threads of the current group are executed once, and the memory blocks corresponding to the this group of threads are set to the low power consumption status, and the memory blocks corresponding to the next group of threads are set to the active status, the status of other memory blocks are kept in the low power consumption status. In this way, the memory blocks required for the threads being currently executed are set to the active status at each moment, and all of other memory blocks are set to the low power consumption status, so as to reduce the power consumption of the memory.

In the storage managing device according to the embodiment of the present invention, the memory blocks with different levels may be further grouped according to the levels of the memory so as to combine with the grouping of the threads. For example, all threads of the system are divided into m groups, and all memory blocks are also divided into m memory block groups according to the levels of the memory, and the thread groups are divided according to the result of dividing the ID value of the threads by m. It is assumed that through computation, t threads of thread 11, 12, . . . , 1t are distributed into the thread group 1, in the same way, i thread of thread 21, 22, . . . , 2i are distributed into the thread group 2, p threads of thread m1, m2, . . . , mp are distributed into the thread group m. And at the same time, rank 0, rank 3, . . . are distributed into the memory rank group 1, rank 1, . . . , rank n are distributed into the memory rank group 2, and m rank groups are distributed in such order. The scheduling procedure is to sequentially schedule the threads in the thread group 1 firstly, and at this time only the memory blocks in the memory block group 1 need to be set to active status, other memory blocks are set to the low power consumption status, after all of the threads in the thread group 1 are executed once, the threads in the thread group 2 are scheduled, and at this time the memory blocks in the memory block group 1 are set to low power consumption status, all memory blocks in the memory block group 2 are set to active status, and other memory blocks are kept in the low power consumption status, and this scheduling is carried out periodically.

As aforementioned, in the storage managing device according to the embodiment of the present invention, the physical memory blocks of a plurality of levels may be grouped into one virtual memory block employing the concept of virtual memory block, thus, the thread can only use one virtual memory block, so as to enlarge the memory quota of the thread and increase the efficiency of the thread.

In the storage managing device according to the embodiment of the present invention, under the configuration of a memory platform of 8 levels of DDR 3, by dividing all threads into 8 groups and dividing the memory blocks of each level into one group as above mentioned, the experiment exhibits that the power consumption of the memory is reduced by 20% when employing the above-described method compared with the conventional scheme.

In the contents mentioned above, the storage managing device according to the embodiment of the present invention is described by taking the memory as example, here, those skilled in the art can understand that the storage device to which the storage managing device in the embodiments of the present invention is applied is not limited to the memory of the computer system, and it can also be other storage device with a plurality of storage blocks. For example, the NVRAM storage device has a plurality of storage regions that are capable of being separated physically, and it can be considered as a storage device composed of a plurality of storage blocks, the NVRAM storage device may be applied to the computer system as the memory or the hard disk of the computer, and it may be used as an internal storage device of other electronic apparatus, e.g., the smart phone or the household appliances, or used as the external portable storage device such as portable hard disk or USB flash disc.

According to another aspect of the embodiment of the invention, there provides a storage managing method applied to a storage device composed of a plurality of storage blocks, comprising: collecting the threads to be executed in a predetermined time; dividing the collected threads into n thread groups based on a predetermined strategy, wherein n is an integer larger than 1; designating one or more storage blocks to each thread group to store the data necessary for execution of each thread group into the one or more storage blocks; executing the threads; and, setting the one or more storage blocks designated to the threads being executed to an active status, while setting other storage blocks to a low consumption status.

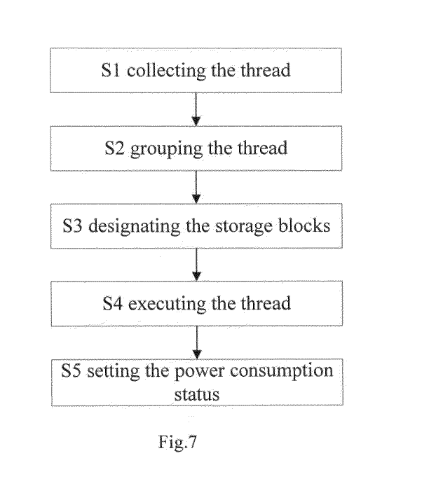

FIG. 7 is a schematic flowchart of the storage managing method according to the embodiment of the present invention. As shown in FIG. 7, the storage managing method according to the embodiment of the present invention is applied to a storage device composed of a plurality of storage blocks, and comprises: S1, collecting the threads to be executed in a predetermined time; S2, dividing the collected threads into n thread groups based on a predetermined strategy, wherein n is an integer larger than 1; S3, designating one or more storage blocks to each thread group to store the data necessary for the execution of each thread group into one or more storage blocks; S4, executing the threads; and, S5, setting the one or more storage blocks designated to the threads being executed to an active status, while setting other storage blocks to a low consumption status.

In the storage managing method, the step of dividing the collected threads into n thread groups based on a predetermined strategy is specified as: based on a residue obtained by dividing the ID value of a thread by n, distributing the thread with the same residue into one thread group.

In the storage managing method, the step of dividing the collected threads into n thread groups based on a predetermined strategy is specified as: determining a storage blocks designated to the thread based on at least one of the category of the thread, the occupancy amount of the storage capacity of the thread and the remaining capacity of the storage blocks; and distributing the threads designated with the same storage block into one thread group.

The storage managing method further comprises: if the threads in a same thread group are not all executed, the threads in the thread group are executed; and, if the thread in a same thread group are all executed, the threads in a next thread group are executed.

The storage managing method, after the step of dividing the collected threads into n thread groups based on a predetermined strategy, further comprises: dividing the plurality of storage blocks into n storage block group; and the step of distributing one or more storage blocks to each thread group is specifically: designating one storage block group to each thread group.

Here, other details of the storage managing method described above according to the embodiment of the present invention are the same as those in the description of the storage managing device according to the embodiment of the present invention, so they are omitted for redundancy.

According to another aspect of the embodiment of the invention, there provides an electronic apparatus, comprising: a storage device composed of a plurality of storage blocks and a controller comprising: a thread collecting unit configured to collect the threads to be executed in a predetermined time; a thread dividing unit configured to divide the collected threads into n thread groups based on a predetermined strategy, wherein n is an integer larger than 1; a thread holding unit configured to designate one or more storage blocks to each thread group to store the data necessary for the execution of each thread group into the one or more storage blocks; a thread executing unit configured to execute the threads, and a power consumption setting unit configured to set the one or more storage blocks designated to the threads being executed to an active status, while set other storage blocks to a low power consumption status.

With the storage managing device and method and the electronic apparatus according to the embodiment of the present invention, the storage blocks used by certain thread group can be restricted to one or more specific storage blocks through the grouping of the thread, so as to reduce the number of the storage blocks being in the active status at the same time in the thread execution process, to reduce the power consumption of the storage device while maintaining the performance of the storage device. Further, since the number of the storage blocks being in the active status is reduced, the temperature of the storage device is lowered correspondingly.

Those skilled in the art can understand that, the units and algorithm steps of the examples described in combination with the embodiments disclosed in the specification can be implemented by an electronic hardware, a computer software or both of them, in order to explain the interchangeability of hardware and software clearly, the constitution and step of the respective examples is described generally according to the function in the above explanation. Whether these functions are implemented by hardware or software depends on the specific application of the technical solution and the design restrictions. Those skilled in the art can use different methods to implement the described function for each specific application, and this implementation should not be regarded as beyond the disclosure of the invention.

Those skilled in the art can understand that, for the convenience and simplicity of description, the detailed operational procedure of the system, apparatus and method can correspond to the corresponding procedure in the method embodiment, and shall not be described any more.

In the several embodiments in the invention, it can be understood that the disclosed system, apparatus and method can be implemented by other means. For example, the apparatus embodiment above mentioned is only schematic, for example, the division of the units is only a logical functional division, and there can be other means of division in practical use, for example, multiple units or components can be combined or integrated into another system, or some features can be omitted, or not operated. Further, the coupling therebetween or the direct coupling or communication connection can be implemented by indirect coupling or communication connection of some interfaces, apparatus and units, and they can be electric, mechanic or in other form.

The units described as separate components may be or may not be physically separated, the components shown as units may be or may not be physical units, i.e., they can be located at a same position, or distributed on a plurality of network units. The object of the solution of the embodiment can be implemented by selecting part or all of the units according to the practical need.

Further, the respective functional units in the respective embodiments of the invention can be integrated into a processing unit, and the respective units can be individual, or two or more of units can be integrated into a unit. The above integrated unit can be implemented in the form of hardware or the form of software functional unit.

If the integrated unit is implemented in the form of software functional unit and sold and used as an individual product, it can be stored in a computer readable storage medium. Based on this understanding, the essential technical solution of the invention or the part contributed to the related art or part or all of the technical solution can be embodied as a software product, and this computer software product is stored on storage medium, includes some instructions to cause a computer (PC, server or networked apparatus, etc.) to perform part or all of the steps of the method of the embodiment of the invention. And the storage medium includes medium storing program code such as U disc, portable hard driver, ROM, RAM, magnetic disc or optical disc, etc.

The content described above is only the preferred mode for carrying out the invention. It should be pointed out that, for those ordinarily skilled in the art, on the condition of not deviating from the principle mentioned in the present invention, several improvements and refinements can be made as well, which should be also treated as the scope protected by the present invention.

1. A storage managing device applied to a storage device composed of a plurality of storage blocks, comprising:
a thread collecting unit configured to collect threads to be executed in a predetermined time;
a thread dividing unit configured to divide the collected threads into n thread groups based on a predetermined strategy, wherein n is an integer larger than 1;
a thread holding unit configured to designate one or more storage blocks to each thread group to store the data necessary for the execution of each thread group into the one or more storage blocks;
a thread executing unit configured to execute the threads; and
a power consumption setting unit configured to set the one or more storage blocks designated to the threads being executed to an active status, while set other storage blocks to a low power consumption status.

2. The storage managing device according to claim 1, wherein,
the predetermined strategy is, based on a residue obtained by dividing the ID value of a thread by n, distributing the thread with the same residue into one thread group.

3. The storage managing device according to claim 1, wherein,
the thread dividing unit is configured to determine a storage block designated to the thread based on at least one of the category of the thread, the occupancy amount of the storage capacity of the thread and the remaining capacity of the storage blocks; and
distribute the threads designated with the same storage block into one thread group.

4. The storage managing device according to claim 1, further comprising:
if the threads in a same thread group are not all executed, the threads in the thread group are executed; and
if the thread in a same thread group are all executed, the threads in a next thread group are executed.

5. The storage managing device according to claim 1, further comprising:
a storage block grouping unit configured to group the plurality of storage blocks into n storage block groups;
wherein, the thread holding unit is configured to designate one storage block group to each thread group.

6. A storage managing method applied to a storage device composed of a plurality of storage blocks, comprising:
collecting threads to be executed in a predetermined time;
dividing the collected threads into n thread groups based on a predetermined strategy, wherein n is an integer larger than 1;
designating one or more storage blocks to each thread group to store the data necessary for the execution of each thread group into the one or more storage blocks;
executing the threads; and
setting the one or more storage blocks designated to the threads being executed to an active status, while setting other storage blocks to a low consumption status.

7. The storage managing method according to claim 6, wherein, the step of dividing the collected threads into n thread groups based on a predetermined strategy is specifically:
based on a residue obtained by dividing the ID value of a thread by n, distributing the thread with the same residue into one thread group.

8. The storage managing method according to claim 6, wherein, the step of dividing the collected threads into n thread groups based on a predetermined strategy is specified as:
determining a storage blocks designated to the thread based on at least one of the category of the thread, the occupancy amount of the storage capacity of the thread and the remaining capacity of the storage blocks; and
distributing the threads designated with the same storage block into one thread group.

9. The storage managing method according to claim 6, further comprising:
if the threads in a same thread group are not all executed, the threads in the thread group are executed; and
if the thread in a same thread group are all executed, the threads in a next thread group are executed.

10. The storage managing method according to claim 6, after the step of dividing the collected threads into n thread groups based on a predetermined strategy, further comprising:
dividing the plurality of storage blocks into n storage block groups;
and the step of designating one or more storage blocks to each thread group is specified as:
designating one storage block group to each thread group.

11. An electronic apparatus, comprising:
a storage device composed of a plurality of storage blocks;
a controller, comprising:
a thread collecting unit configured to collect threads to be executed in a predetermined time,
a thread dividing unit configured to divide the collected threads into n thread groups based on a predetermined strategy, wherein n is an integer larger than 1;
a thread holding unit configured to designate one or more storage blocks to each thread group to store the data necessary for the execution of each thread group into the one or more storage blocks;
a thread executing unit configured to execute the threads; and
a power consumption setting unit configured to set the one or more storage blocks designated to the threads being executed to an active status, while set other storage blocks to a low power consumption status.
